(19) United States
(12) Patent Application Publication
(10) Pub. No.: US 2009/0189907 A1
(43) Pub. Date: Jul. 30, 2009

(54) MEDICAL SUPPORT CONTROL SYSTEM

(76) Inventors: Koichi TASHIRO, Sagamihara (JP); Masaru ITO, Yokohama (JP)

Correspondence Address: OSTROLENK FABER GERB & SOFFEN, 1180 AVENUE OF THE AMERICAS, NEW YORK, NY, 100368403, US

(21) Appl. No.: 12/021,651

(22) Filed: Jan. 29, 2008

(51) Int. Cl. G06F 15/16

(52) U.S. Cl. 345/502

(57) ABSTRACT

A medical support control system that can control a medical device, comprising: a plurality of video interface cards that are detachable from the medical support control system and that are used for the medical support control system for converting, when a video signal is input from an external environment, the video signal input from the external environment into a common signal and vice versa, said common signal being different from any video signals input into and output from the plurality of video interface cards and said common signal being commonly used in the medical support control system, and for detecting a change in an information amount of the input video signal; and a switching control card for determining, when it is determined that the video signal was switched on the basis of the detection result, an output path for the common signal obtained by the conversion on the video signal.

### BACKGROUND OF THE INVENTION

1. Field of the Invention

The present invention relates to a medical support control system for controlling medical devices and non-medical devices used for operations.

2. Description of the Related Art

Operating systems using medical controllers or the like for controlling medical devices such as endoscopes or the like used for operations have been proposed. Medical devices to be controlled such as electric knives, insufflation devices, endoscope cameras, light source devices, or the like are connected to the medical controller (also referred to as MC). Also, a display device, a manipulation panel, or the like is connected to the MC. The manipulation panel includes a display unit and a touch sensor, and is used as a central manipulation device by nurses or the like working in an unsterilized area. The display device is used for displaying endoscope images or the like.

There is audio-visual equipment in the operating room such as a room light, a room camera, an interphone device, a liquid crystal display device, or the like (non-medical devices). The audio-visual equipment is controlled independently or by a non-medical controller (also referred to as an NMC) used for the central control.

Japanese Patent Application Publication No. 2006-000536, for example, discloses an operating system, comprising:

a first controller connected to a medical device provided in an operating room;

a second controller connected to a non-medical device provided in the operating room; and

manipulation instruction input means transmitting to the first controller the content of a manipulation instruction when the manipulation instruction for the medical device or the non-medical device is input. The first controller transmits to the second controller a first control signal in accordance with the manipulation instruction of the non-medical device input into the manipulation instruction means. The second controller converts the first control signal into a second control signal used for controlling the non-medical device, and transmits the second control signal to the non-medical device. Thereby, the operating system and a non-medical system work together, and the operating person himself/herself or the like can manipulate the non-medical devices.

### SUMMARY OF THE INVENTION

One aspect of the present invention is a medical support control system that can control a medical device, comprising:

a plurality of video interface cards that are detachable from the medical support control system and that are used for the medical support control system for converting, when a video signal is input from an external environment, the video signal input from the external environment into a common signal and vice versa, said common signal being different from any video signals input into and output from the plurality of video interface cards and said common signal being commonly used in the medical support control system, and for detecting a change in an information amount of the input video signal; and

a switching control card for determining, when it is determined that the video signal was switched on the basis of the detection result, an output path for the common signal obtained by the conversion on the video signal.

Another aspect of the present invention is a medical support control system wherein:

the medical support control system further comprises a video processing card for performing image processing; and

the switching control card outputs through a prescribed video interface card, when it is determined that the video signal was switched, the common signal obtained by the conversion on the video signal input via the video processing card.

### BRIEF DESCRIPTION OF THE DRAWINGS

FIG. 1 shows an entire configuration of a medical device control system according to the present embodiment;

FIG. 2 is a block diagram showing an entire configuration of a medical support control system 100 according to the present embodiment;

FIG. 3 is a side view showing a configuration of the rear panel of an NMC according to the present embodiment;

FIG. 4 shows a configuration of a video interface card;

FIG. 5 shows a configuration of a switching control card;

FIG. 6 shows a configuration of a video processing card;

FIG. 7 shows a flow of video signals from an endoscope to the NMC; and

FIG. 8 shows a flow of signals when video signals were switched.

### DESCRIPTION OF THE PREFERRED EMBODIMENTS

Hereinafter, the embodiments of the present invention will be explained in detail, referring to the drawings.

A medical support control system according to the present embodiment includes a medical device control system and a non-medical device control system. The medical device control system includes a plurality of medical devices and a medical controller for controlling these medical devices. The non-medical device control system includes non-medical devices (that may further include medical devices) that are used for operations, and a non-medical controller for controlling these non-medical devices.

An endoscopic operating system will be explained as an example of the medical device control system.

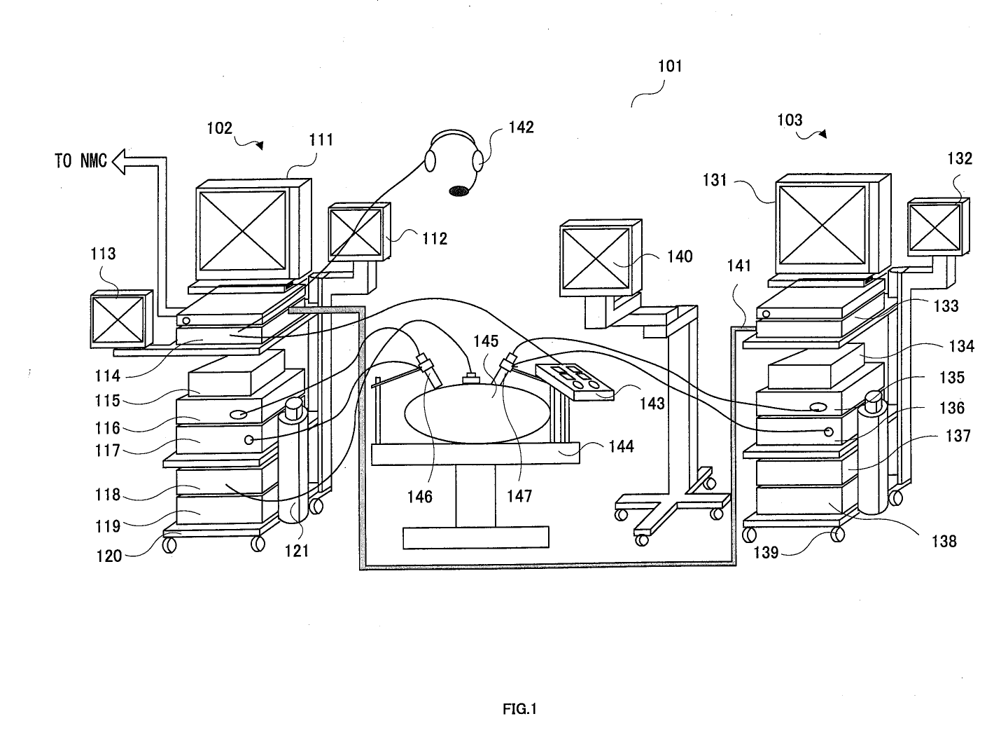

FIG. 1 shows an entire configuration of the medical device control system according to the present embodiment. An endoscopic operating system is shown as a medical device control system 101. In the operating room, a first endoscopic operating system 102 and a second endoscopic operating system 103 beside a bed 144 on which a patient 145 is laid and a wireless remote controller 143 for the operating person are provided.

The endoscopic operating systems 102 and 103 respectively have first and second trolleys 120 and 139 each including a plurality of endoscope peripheral devices used for observation, examination, procedures, recoding, and the like. Also, an endoscope image display panel 140 is arranged on a movable stand.

On the first trolley 120, an endoscope image display panel 111, a central display panel 112, a central manipulation panel device 113, a medical controller (MC) 114, a recorder 115, a video processor 116, an endoscope light source device 117, an insufflation unit 118, and an electrical surgical device 119 are arranged.

The central manipulation panel device 113 is arranged in a unsterilized area to be used by nurses or the like in order to manipulate the respective medical devices in a centralized manner. This central manipulation panel device 113 may include a pointing device such as a mouse, a touch panel, or the like (not shown). By using the central manipulation panel device 113, the medical devices can be managed, controlled, and manipulated in a centralized manner.

The respective medical devices are connected to the MC 114 via communication cables (not shown) such as serial interface cables or the like, and can have communications with one another.

Also, a headset-type microphone 142 can be connected to the MC 114. The MC 114 can recognize voices input through the headset-type microphone 142, and can control the respective devices in accordance with the voices of the operating person.

The endoscope light source device 117 is connected to a first endoscope 146 through a light-guide cable used for transmitting the illumination light. The illumination light emitted from the endoscope light source device 117 is provided to the light guide of the first endoscope 146 and illuminates the affected areas or the like in the abdomen of the patient 145 into which the insertion unit of the first endoscope 146 has been inserted.

The optical image data obtained through the camera head of the first endoscope 146 is transmitted to a video processor 116 through a camera cable. The optical image data undergoes signal processing in a signal processing circuit in the video processor 116, and the video signals are created.

The insufflation unit 118 provides CO₂ gas to the abdomen of the patient 145 through a tube. The CO₂ gas is obtained from a gas tank 121.

On the second trolley 139, an endoscope image display panel 131, a central display panel 132, a expansion unit 133, a recorder 134, a video processor 135, an endoscope light source device 136, and other medical devices 137 and 138 (such as an ultrasonic processing device, a lithotripsy device, a pump, a shaver, and the like) are arranged. These respective devices are connected to the expansion unit 133 through cables (not shown), and can communicate with one another. The MC 114 and the expansion unit 133 are connected to each other through the expansion cable 141.

The endoscope light source device 136 is connected to a second endoscope 147 through the light-guide cable for transmitting the illumination light. The illumination light emitted from the endoscope light source device 136 is provided to the light guide of the second endoscope 147, and illuminates the affected areas or the like in the abdomen of the patient 145 into which the insertion unit of the second endoscope 147 has been inserted.

The optical image data obtained through the camera head of the second endoscope 147 is transmitted to a video processor 135 through a camera cable. The optical image data undergoes signal processing in a signal processing circuit in the video processor 135, and the video signals are created. Then, the video signals are output to the endoscope image display panel 131, and endoscope images of the affected areas or the like are displayed on the endoscope image display panel 131.

Further, the MC 114 can be controlled by the operating person manipulating the devices in the unsterilized area. Also, the first and second trolleys 120 and 139 can include other devices such as printers, ultrasonic observation devices, or the like.

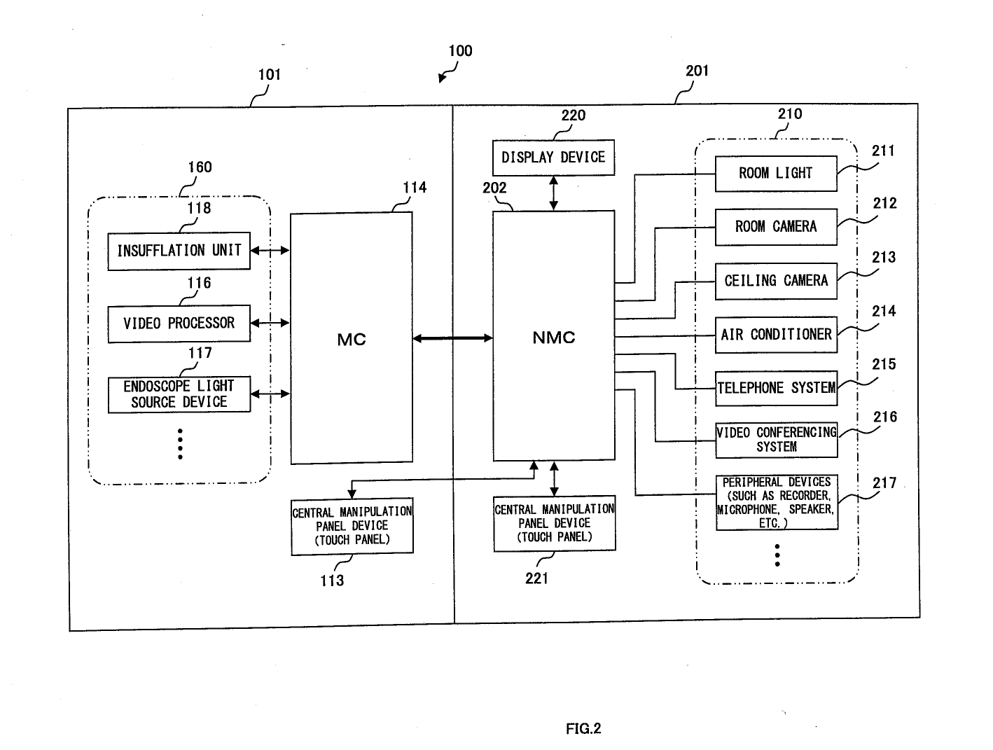

FIG. 2 is a block diagram showing an entire configuration of a medical support control system 100 according to the present embodiment. As described above, the medical support control system 100 includes the medical device control system 101 and a non-medical device control system 201. A detailed configuration of the medical device control system 101 is as shown in FIG. 1. However, in FIG. 2, the medical device control system 101 is shown in a simplified manner for simplicity of explanation.

In FIG. 2, a medical device group 160 is a group of medical devices that are directly connected to the medical controller 114 or are indirectly connected to the MC 114 via the expansion unit 133. Examples of the devices included in the medical device group 160 are the insufflation unit 118, the video processor 116, the endoscope light source device 117, the electrical surgical device 119, and the like.

The central manipulation panel device 113 has a touch panel, and in accordance with the information input into the touch panel, the devices connected to the MC 114 or a non-medical device controller (NMC) 202 that will be described later can be manipulated.

The non-medical control system 201 includes the NMC 202 connected to the MC 114 through a communication cable or the like, and a non-medical device group 210. In this configuration, the NMC 202 can transmit and receive, through an image cable, the video signals to and from the medical device group 160 connected to the MC 114.

The NMC 202 controls the non-medical devices (including the audio-visual devices) connected thereto. As shown in FIG. 2, the non-medical device group 210 connected to the NMC 202 according to the present embodiment consists of a room light 211, a room camera 212, a ceiling camera 213, an air conditioner 214, a telephone system 215, a conference system 216 to be used for individuals in remote places (referred to as a video conference system hereinafter), and other peripheral devices 217. Further, a display device 220 and a central manipulation panel device 221 are connected to the NMC 202.

Also, the non-medical device group 210 includes equipment such as light devices provided in the operating room in addition to the AV devices used for recording and reproducing image data.

The display device 220 is a plasma display panel (PDP) or a liquid crystal display (LCD) device, and displays images of the predetermined device or images of the devices selected by nurses or the like through the central manipulation panel device 221. The room light 211 is a device that illuminates the operating room. The room camera 212 is used for shooting images of the situations in the operating room. The ceiling camera 213 is a camera suspended from the ceiling whose positions can be changed. The conference system 216 is a system that displays images and transmits voices of nurses or the like in the medical office or the nurse stations, and enables conversations with them. The peripheral devices 217 are, for example, a printer, a CD player, a DVD recorder, and the like. The central manipulation panel device 221 has a touch panel that is the same as that included in the central manipulation panel device 113, and controls the respective AV devices connected to the NMC 202. The central manipulation panel devices 113 and 221 are referred to as TPs hereinafter.

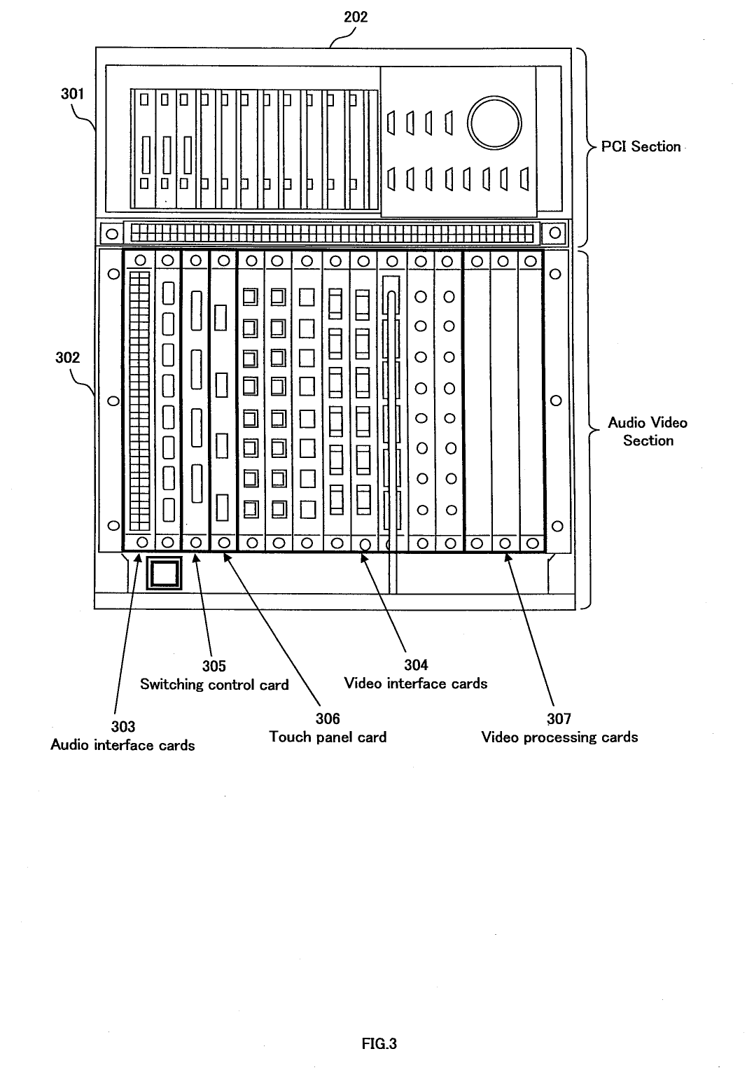

FIG. 3 is a side view showing a configuration of the rear panel of the NMC 202 according to the present embodiment.

The NMC 202 includes a PCI section 301 and an audio/video section 302.

The PCI section communicates with devices connected to the external environment, and has cards having relay devices and the functions of the RS232C, the digital I/O, the ether net, and the modem in order to control devices in the non-medical device group 210 that are connected to other cards that will be described later.

The audio/video section 302 includes audio interface cards 303 (AIC), video interface cards 304 (VIC), a switching control card 305 (SCC), a touch panel card 306 (TPC), and video processing cards 307 (VPC). Additionally, the respective cards included in the audio/video section 302 of the NMC 202 are detachable.

The AICs 303 are inserted into a plurality of slots for the AICs 303 in order to receive, process (amplify, for example), and output audio signals input from a device such as an IC or the like that includes a transmitter/receiver existing in the external environment.

Each of the VICs 304 creates, when a video signal is input into it from the external environment, a common signal, said common signal being different from any of the video signals input into and output from the VICs 304 and said common signal being used commonly in the NMC 202.

In this configuration, examples of the video signals include an HD/SD-SDI (High Definition/Standard Definition-Serial Digital Interface) signal, an RGB/YPbPr signal, an S-Video signal, a CVBS (Composite Video Blanking and Sync) signal, a DVI-I (Digital Visual Interface Integrated) signal, an HDMI (High-Definition Multimedia Interface) signal, and the like.

Also, the VICs 304 have a function of converting the common signals into video signals that are appropriate to the output destinations. Also, the VICs 304 can be inserted into a plurality of slots for the VICs 304. Also, the VICs 304 can have a common interface connector 405. Also, the VICs 304 use paths for directly outputting the input video signals without converting the signals when the VICs 304 are turned off.

The SCC 305 selects the VIC 304 as the output destination in accordance with instructions given from the external environment. Also, the SCC 305 obtains VIC-related information including identification information used for identifying the VICs 304 and position information specifying the positions of the corresponding VICs 304. Then, the SCC 305 detects, on the basis of the VIC-related information, the position of the VIC 304 as the output destination set in accordance with the instruction given from the external environment, selects the VIC 304 as the output destination for the common signal, and determines whether or not this output should be made via the VPC 307.

The SCC 305 is connected to the TP 221 via, for example, the TPC 306, and the manipulator sets, in the SCC 305, which of the VICs 304 is to be selected as the output destination and whether or not the output should be made via the VPC 307.

The VPC 307, in accordance with the video signals expressed by the common signals, processes the input signals into video signals appropriate to the selected VIC 304.

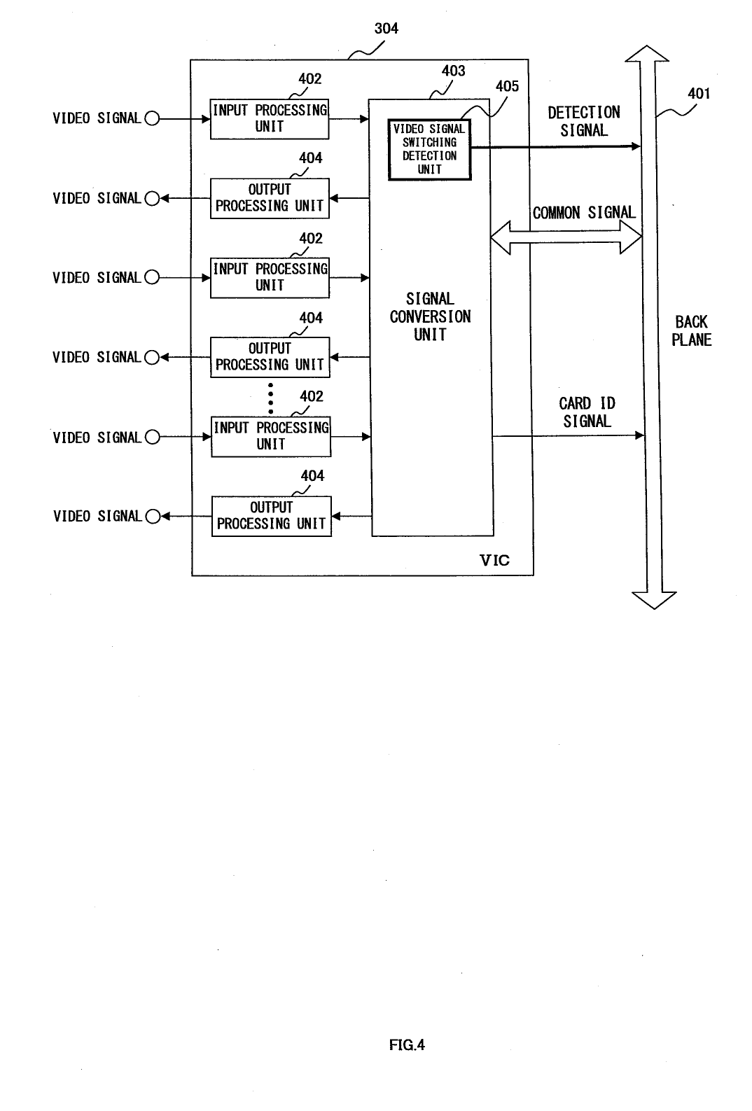

FIG. 4 shows a configuration of the VIC 304.

The VIC 304 is attached to a back plane 401, and includes an input processing unit 402, a signal conversion unit 403, an output processing unit 404, and a connector 405. In this configuration, the back plane 401 includes slots into which the audio interface cards (AIC) 303, the video interface cards (VIC) 304, the switching control card (SCC) 305, a touch panel card (TPC) 306, and the video processing cards (VPC) 307 are inserted. These cards perform communications via the back plane 401.

The VICs 304 transmit and receive, through the back plane 401, the common signals that are obtained by converting the video signals by using the signal conversion unit 403, the common signals input through the cards other than the VICs 304, the identification information for identifying the VICs 304, and the position information for specifying the positions of the slots into which the VICs have been inserted.

The input processing unit 402 receives the video signals output from devices (medical devices and non-medical devices) that are connected to the NMC 202 and are used for outputting video signals, and transfers the received video signals to the signal conversion unit 403.

The signal conversion unit 403 converts the common signal, said common signal being different from any of the video signals input into and output from the VICs 304 and said common signal being used commonly in the NMC 202, into video signals, and vice versa.

In other words, the signal conversion unit 403 converts the video signal input from the input processing unit 402 into the common signals, and outputs the common signals to the back plane 401. Also, the signal conversion unit 403 obtains the common signal input into the VICs 304 via the back plane 401, and converts the obtained signals into video signals appropriate to the selected VIC 304.

Also, the signal conversion unit 403 outputs, via the back plane 401, VIC-related information (a card ID signal) consisting of the identification information used for identifying the VIC 304 and the position information specifying the position of the slot into which the VIC 304 has been inserted.

The output processing unit 404 outputs the video signals obtained by the conversion by using the signal conversion unit 403.

The video signal switching detection unit 405 detects an amount of information of the video signals input from the input processing unit 402. When, for example, HD-SDI signals, i.e., signals that are not SD-SDI signals, are input into the input processing unit 402 which outputs the signals to the SCC 305 after obtaining the SD-SDI signals and converting them into common signals, the video signal switching detection unit 405 detects the fact that the video signals were switched on the basis of the information amount of the video signals (for example, the resolution, whether it is interlaced/progressive, the frame rate, or the like), and transmits a detection signal to the SCC 305 via the back plane 401.

Additionally, even though the video signal switching detection unit 405 is provided in the signal conversion unit 403, the video signal switching detection unit 405 can be provided in each of the input processing units 402.

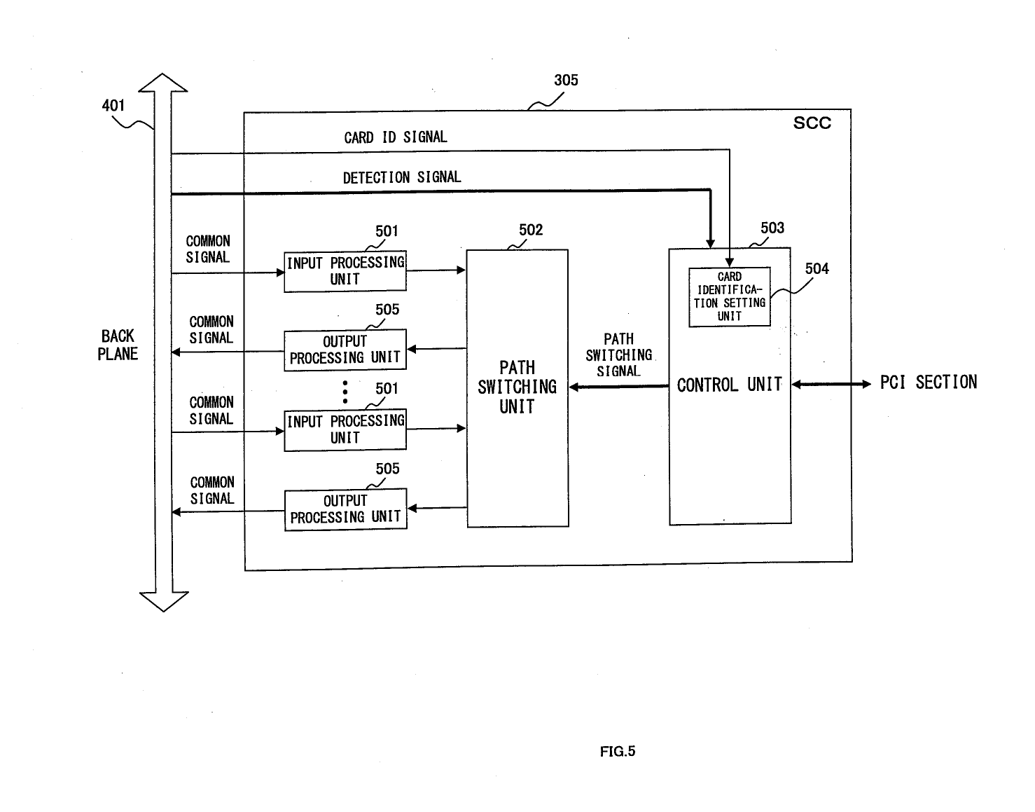

FIG. 5 shows a configuration of the SCC 305.

The SCC 305 is attached to the back plane 401, includes an input processing unit 501, a path switching unit 502, a control unit 503, and an output processing unit 505, and switches the paths for the serialized common signals.

The input processing unit 501 receives the common signals input from the back plane 401 and transfers the received signals to the path switching unit 502.

The path switching unit 502 switches the paths for the common signals. For example, the path switching unit 502 determines, on the basis of the path switching signals output from the control unit 503, the path for the common signal to be output to the output-destination VIC 304. Also, when image processing is to be performed in the VPC 307, the path switching unit 502 determines, on the basis of the path switching signal, the path for the common signal to be output to the output-destination VPC 307. Also, the path switching unit 502 determines the path to the VIC 304 for the common signal that is output from the VPC 307 after the image processing.

The control unit 503 includes a card identification setting unit 504 and a signal conversion unit 506 in order to transfer control signals input into the PCI section 301 from the external connection device and to control the respective units in the SCC 305 by obtaining control signals input from the PCI section 301.

The card identification setting unit 504 in the control unit 503 outputs path switching signals on the basis of the identification information and the position information in the VIC-related information (card ID signal) and on the basis of selection information of the output-destination VIC 304 and the VPC 307 set in accordance with the control signals from the external connection device.

In order to perform setting from the external environment, selection information for the output-destination VIC 304 is set in the card identification setting unit 504 from, for example, the TPs 113 and 221 in order to cause the input-destination VIC 304 and the output-destination VIC 304 to correspond to each other. By establishing this correspondence, the position of the output-destination VIC 304 is detected from the VIC-related information in order to determine the output-destination VIC 304 for the common signals.

Also, when it is determined that the detection signal created in the VIC 304 was obtained and the video signals input from the VIC 304 were switched, an output path for a common signal obtained by converting the video signal is changed. The output path for the common signal is such that the common signal goes from the SCC 305 to the VPC 307 where the signals are converted into the other type of common signal and is output again via the SCC 305 to a prescribed VIC 304. This setting of the path is also performed on the basis of the path switching signal.

The output processing unit 505 outputs, to the output-destination VIC 304 set in the above step, the common signals output from the path switching unit 502.

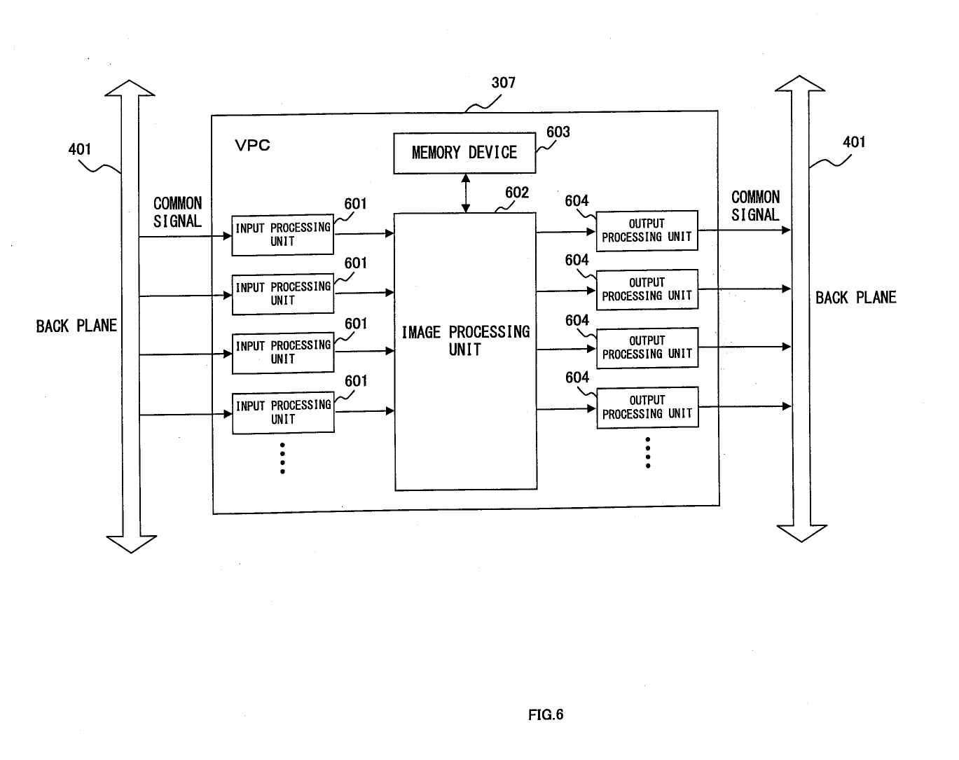

FIG. 6 shows a configuration of a VPC 307.

The VPCs are attached to the back plane 401, and include an input processing unit 601, an image processing unit 602, a memory device 603, and an output processing unit 604.

The input processing unit 601 receives the common signals input from the back plane 401, and transfers the received common signals to the image processing unit 602.

The image processing unit 602, on the basis of the video signals expressed by the common signals, processes the signals into video signals appropriate to the selected VIC 304, and also holds the common signals input from the input processing unit 601 in the memory device 603, and performs image processing on the held common signals in order to output the signals. It is also possible that the common signals undergo the image processing after being converted into the prescribed video signals.

The above image processing includes, for example, the de-interlacing, the rate control, the scaling, the mirror, the rotation, the picture in picture (PIP), the picture out picture (POP), and the like.

The output processing unit 604 transfers, to the SCC 305 via the back plane 401, the common signals that have undergone the image processing performed by the image processing unit 602.

Also, the VPC 307 has a signal conversion function, and when a video signal in a different format is input into the VIC 304, the VPC 307 obtains a common signal from the SCC 305, converts the common signal into a common signal that corresponds to a desired video signal, and again outputs the signal to the SCC 305.

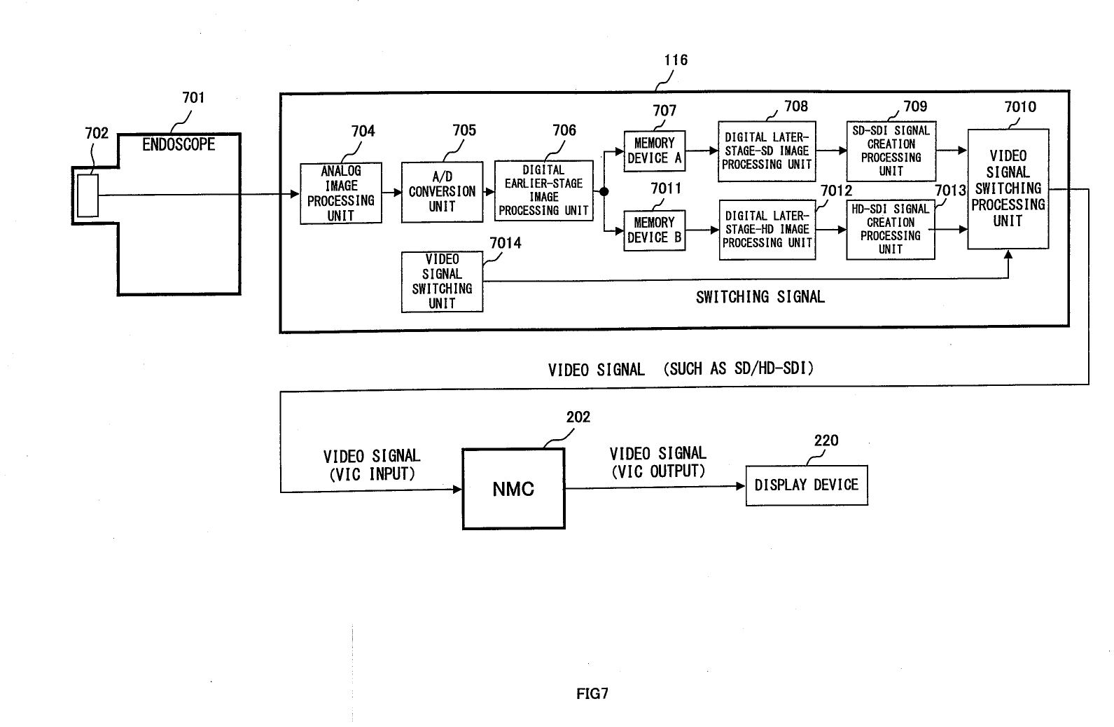

The endoscope system shown in FIG. 7 includes an endoscope 701, a video processor 116, the MC 114, and the NMC 202.

The endoscope 701 has various CCDs 702, and is connected to the endoscope light source device 117 and the video processor 116. The endoscope 701 performs the endoscopic examination or the like by being inserted into body cavities. The endoscope light source device 117 is detachably connected to the connector of the endoscope 701 to which illumination light is to be provided.

The video processor 116 detachably connected to the endoscope 701 can perform signal processing corresponding to various CCDs 702. Additionally, only one endoscope 701 is shown in FIG. 7; however, in the actual configuration, a plurality of types of endoscopes whose CCDs 702 yield different numbers of pixels (resolutions) are connected to the video processor 116.

The CCDs 702 correspond respectively to two types of video signals, the SDTV signal (standard-definition TV signal) and the HDTV signal (such as a high-definition video signal).

The video processor 116 is a signal processing device for endoscope signals used for performing signal processing for image shooting means included in the endoscope 701; it receives video signals via the connector that is detachably connected and transfers to the NMC 202 the endoscope images shot by the image shooting means.

The video processor 116 has a function of performing signal processing in which SD signals appropriate to the CCD 702 included in the endoscope 701 are created and a function of performing signal processing in which HD signals are created.

Because the endoscope 701 is connected to the video processor 116, the CCD driver (not shown) provided in the video processor 116 applies CCD drive signals to the CCD 702. The CCD 702 outputs, to an analog image processing unit 704 in the video processor 116, CCD output signals that have undergone photoelectric conversion performed with the CCD drive signals applied.

The output signals from the above CCD 702 undergo processing such as amplification, correlated double sampling, or the like performed by the analog image processing unit 704, are input into an A/D conversion unit 705, and are converted from analog to digital.

This digital signal is input into a digital earlier-stage image processing unit 706, undergoes processing such as a color division process in which the signal is divided into luminance signals and color signals, and also undergoes matrix processing in which the luminance signals and the color signals are converted into RGB signals, a white balance signal, and the like; thereafter, the divided signals are temporarily stored in two memory devices (a memory device A 707 and a memory device B 7011). The signal read from these two memory devices undergoes a signal processing corresponding to the SD signals (standard-definition video signals) and the HD signal (high-definition video signal) yielding higher resolution than the SD signal, as will be explained later.

The signal read from the memory device A 707 is input into a digital later-stage-SD image processing unit 708, and in this digital later-stage-SD image processing unit 708, processing such as enlargement processing, enhancement processing, or the like is performed on the basis of SDTV. Thereafter, the output signal from this digital later-stage-SD image processing unit 708 is input into an SD-SDI signal creation processing unit 709 that converts signals into serial video signals. The SD-SDI signal creation processing unit 709 has a serial digital interface (SDI), and converts the SD signals into serial video signals.

Also, the signal read from the memory device B 7011 is input into a digital later-stage-HD image processing unit 7012. Then, in this digital later-stage-HD image processing unit 7012, processing such as enlargement processing, enhancement processing, or the like is performed on the basis of HDVT.

SD and HD have different aspect ratios, and accordingly the digital later-stage-SD image processing unit 708 and the digital later-stage-HD image processing unit 7012 correspond to the respective aspect ratios and perform the same processes.

Thereafter, the output signal of this digital later-stage-HD image processing unit 7012 is input into an HD-SDI signal creation processing unit 7013 for converting the signal into serial video signals. The serial output signals of the SD-SDI signal creation processing unit 709 and the HD-SDI signal creation processing unit 7013 are input into the display device 220 via a video signal switching processing unit 7010 and the NMC 202.

The video signal switching processing unit 7010 outputs the video signals selected on the basis of the switching signal for the video signals that are the SD or HD selection instruction given from, for example, a video signal switching unit 7014.

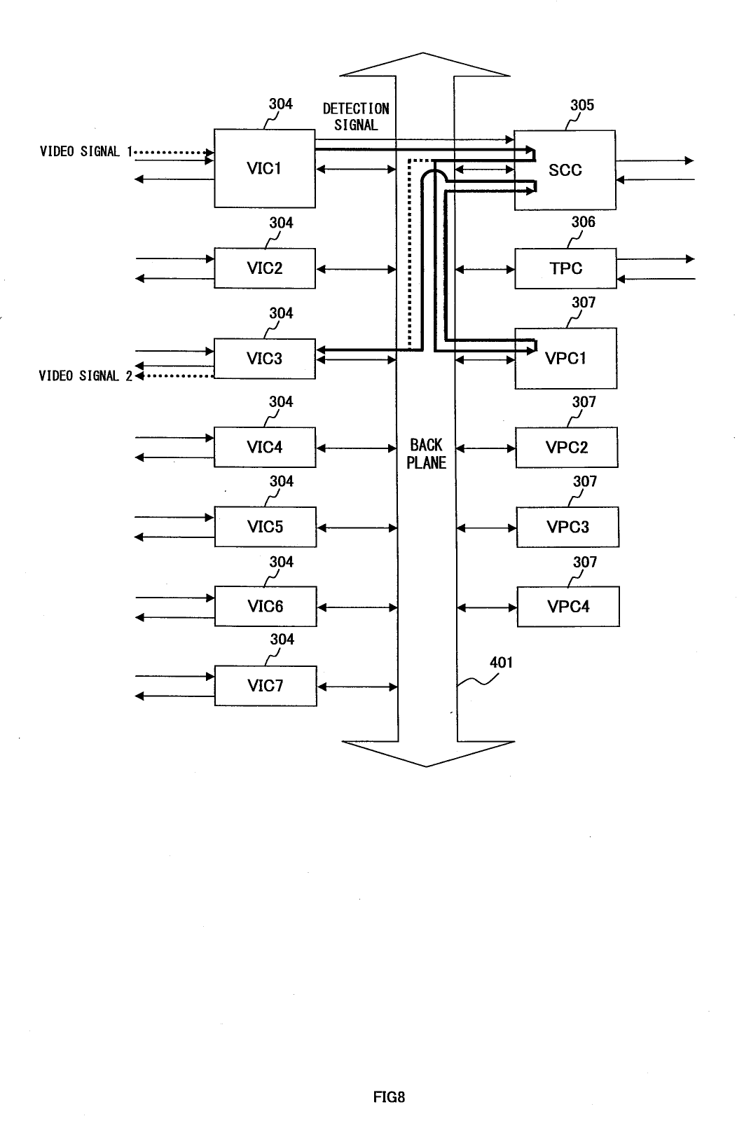

FIG. 8 shows a flow of signals when video signals transferred from the medical device group 160 such as the endoscope system or the like are displayed on the prescribed display device 220. In FIG. 8, explanations are given on the assumption that the video signal input 5 into the VIC 304 is the SD-SDI signal or the HD-SDI signal that was transferred from the endoscope 701 (explained in FIG. 8).

The video signals input into the VIC 304 are converted into common signals, and are output, via the SCC 305, to the output-destination VIC 304 that is set by the SCC 305. However, when an input device (such as a keyboard, a mouse, or the like) connected to the video processor is used to switch the video signals, the image being output is intermitted.

In order to cope with this phenomenon, an attempt is made so that images being displayed on the display device 220 used as an output device are not intermitted even when the video signals are switched. For example, signals are output so that even when the SD-SDI signals are switched to the HD-SDI signals, images being displayed on the output device corresponding to the SD-SDI signals are not intermitted.

The video signal switching detection unit 405 shown in FIG. 4 detects the fact that the video signals were switched by the VIC 304. Then, the video signal switching detection unit 405, by using the detection signal, notifies the control unit 503 in the SCC 305 of the fact that the video signals were changed. On the basis of this detection signal, the SCC 305 again sets the path for outputting the signal to the output-destination VIC 304 via the VPC 307.

When, for example, the SD-SDI signals that have been input into the SD/HD-SDI input terminal in the VIC 304 are switched to HD-SDI signals, the HD-SDI signals are converted into common signals, and are transferred to the SCC 305 and the VPC 307 by the VIC 304. In the VPC 307, the common signals (HD-SDI) are converted into the common signals (SD-SDI) (HD/SD conversion).

Inversely when the HD-SDI signals are changed to the SD-SDI signals, the VPC converts the common signals (SD-SDI) into the common signals (HD-SDI) (SD/HD conversion).

Additionally, in the above configuration, the SD/HD conversion has been explained; however, the signal conversion for the RGB/YPbPr, S-Video, CVBS, DVI-I, and HDMI is also performed in the same manner when switching occurs.

In this configuration, the VPC 307 can directly convert common signals, and also can convert the common signals again after converting the common signal into image-like signals. “Image-like signals” means common signals in a state that is necessary for the VPC 307 in order to perform conversion processing. For example, the signal is converted into image signals such as the SD-SDI, RGB/YPbPr, S-Video, CVBS, DVI-I, and HDMI.

In FIG. 8, before the signal switching occurs, a video signal 1 is input into the VIC1 304 and the common signal obtained by converting the video signal 1 passes through the SCC 305, and is converted again into a prescribed video signal 2 in the VIC3 304 and is output (the path represented by the dotted line in FIG. 8).

When the switching has occurred, the video signal 1 input from the VIC1 304 is transferred to the SCC 305 after making the changed video signal 1 the common signal. Thereafter, the common signal is transferred to the VPC1 307 on the basis of the switching path of the SCC 305 that was set again in accordance with the detection signal. When the signal conversion is completed in the VPC1 307, the converted common signal is transferred to the SCC 305, and is transferred to the prescribed VIC3 304; thereafter the video signal 2 is output.

When XGA is fixed in the setting for the output devices such as the display device 220, any signal regardless of whether it is the SD signal or the HD signal is transmitted via the VPC 307.

Also, when the output device has an automatic switching function for video signals, video signals that can be switched by the output device are recorded in advance, and the current path (VIC 304→SCC 305→VIC 304) is maintained without setting the path via the VPC 307 even when switching to the recorded video signal.

Further, when a common signal has the same resolution, frame rate, and scanning method, it is possible for the signal to be transmitted via a route other than the VPC 307. For example, when the S-Video signal (NTSC) is changed to the CVBS signal (NTSC), the S-Video signal is changed to the common signal in the VIC 304, is converted into the CVBS signal (NTSC) in the output-destination VIC 304, and is output.

By using the above configuration, a medical support control system that can control medical devices and non-medical devices can be provided.

In the above configuration, even when the format of the input signals is changed, conversion into video signals appropriate to the output devices can be performed on the basis of the result of the automatic detection, and accordingly the above problem can be avoided.

In other words, the conventional problem can be avoided, in which, if a user changes a signal to one that is not compatible with the device when the format of signals of the display devices is limited, the image disappears (for example, the displayed image or the recorded image is blacked out), or the change causes damage to devices.

“Damage to devices” includes the situation in which non-standard video signals are successively input into a device which is included in a display device and receives video signal. For example, a situation in which signals are successively input at a level above the standard.

Also, users can switch signals without being concerned about the input format of the output devices.

The scope of the present invention is not limited to the above embodiments, and various alterations and modifications are allowed without departing from the spirit of the present invention.

What is claimed is:

1. A medical support control system that can control a medical device, comprising:
a plurality of video interface cards that are detachable from the medical support control system and that are used for the medical support control system for converting, when a video signal is input from an external environment, the video signal input from the external environment into a common signal and vice versa, said common signal being different from any video signals input into and output from the plurality of video interface cards and said common signal being commonly used in the medical support control system, and for detecting a change in an information amount of the input video signal; and
a switching control card for determining, when it is determined that the video signal was switched on the basis of the detection result, an output path for the common signal obtained by the conversion on the video signal.

2. The medical support control system according to claim 1, wherein:
the medical support control system further comprises a video processing card for performing image processing; and
the switching control card outputs through a prescribed video interface card, when it is determined that the video signal was switched, the common signal obtained by the conversion on the video signal input via the video processing card.

3. The medical support control system according to claim 2, wherein:
the common signal is a serial signal.

4. The medical support control system according to claim 2, wherein:
the video processing card performs a signal conversion process on a common signal when the video signal was switched.

5. The medical support control system according to claim 2, wherein:
the signal conversion process is SD/HD conversion or HD/SD conversion.
